(19) United States
(12) Patent Application Publication
(10) Pub. No.: US 2016/0034514 A1
(43) Pub. Date: Feb. 4, 2016

(54) PROVIDING SEARCH RESULTS BASED ON AN IDENTIFIED USER INTEREST AND RELEVANCE MATCHING

(71) Applicant: Regents of the University of Minnesota, Minneapolis, MN (US)

(72) Inventors: Ayush Singhal, Minneapolis, MN (US); Ravindra Kasturi, Redmond, WA (US); Jaideep Srivastava, Plymouth, MN (US)

(21) Appl. No.: 14/817,892

(22) Filed: Aug. 4, 2015

Related U.S. Application Data
(60) Provisional application No. 62/032,843, filed on Aug. 4, 2014.

(51) Int. Cl. G06F 17/30

(52) U.S. Cl. CPC G06F 17/30345; G06F 17/30867; G06F 17/3053; G06F 17/30011; G06F 17/30528

(57) ABSTRACT

Computerized systems for providing interest-to-item matching when item metadata is lacking or unavailable such that desired items of interest (e.g., research datasets) may be located for a user. For instance, the computing system may generate a context of a user's interest based on information indicating the user's interest (e.g., authors of research document, title of research document), and use the context to identify potentially relevant items and determine the relevance of the items to the user's interest. Additionally, a searchable database of items is generated by extracting identifiers of low content items from publicly available sources, such as the Internet, and generating contexts for the identified items. The computing system then indexes the identified items in the database using the generated contexts thereby enabling users to search the database for items of interest. Moreover, generating a context for items provides better accessibility for items that have little or no indexable content (e.g., metadata).

This application claims the benefit of U.S. Provisional Patent Application No. 62/032,843, filed Aug. 4, 2014, the entire contents of which are incorporated herein by reference.

### STATEMENT REGARDING FEDERALLY SPONSORED RESEARCH OR DEVELOPMENT

This invention was made with government support under W911NF-09-2-0053 and W911NF-12-C-0028 awarded by Army Research Laboratory and DARPA. The government has certain rights in the invention.

### BACKGROUND

Users' day-to-day needs, ranging from shopping items, books, news articles, songs, movies, research documents and other basic items, have flooded online data-warehouses and databases, both in volume and variety. To this end, intelligent network-based recommendation systems and powerful search engines strive to offer users a helpful hand in sifting through the myriad of items to locate items of interest. The popularity and usefulness of such systems owes to their capability to manifest convenient information from a practically infinite storehouse. Modern recommendation systems may take initiative to learn a user's interests and inform the user about items pertaining to those interests.

While progress has been made in developing techniques for matching user interests to items, most approaches assume that metadata for relevant items (e.g. descriptions of items, properties of items, ratings for items, etc.) is readily available. In some cases, however, little or no metadata information is available about items of interest, and the items themselves may provide little searchable and/or indexable content. For instance, the raw content of research datasets are generally not indexed by search engines such as Google or Bing. Thus, given the seemingly infinite variety of research datasets available via the Internet, a common problem faced by several data mining researchers (e.g., especially those working in inter-disciplinary areas) is identifying relevant datasets for a particular research problem. Moreover, while some items generally have a common database source, items such as research datasets may not yet have a single common repository.

### SUMMARY

Techniques are described for an overall framework for interest-to-item matching when item metadata is lacking or unavailable. As such, the techniques of the present disclosure may provide a novel approach to find items of interest from the context of a user's interest even when little metadata is available for the individual items, thereby enabling improved and potentially automated searches among items having little or no metadata information.

In one example, given a user's interest, the techniques described herein enable a computing system to generate a context of an item by extending the context around the user's interest using an external database. The computing system may then identify datasets from the context by using web intelligence (e.g., search engines and an online thesaurus). Finally, the computing system models the ranking of the identified datasets to maximize the accuracy of the recommendations.

In one example, the techniques described herein leverage open source information sources (e.g., academic search engines) for generating content, thus overcoming the problem of content creation for research datasets. A system configured in accordance with the techniques of the present disclosure may utilize algorithmic approaches to populate content for research datasets. The content includes different types of fields for the datasets. The database may consist of datasets from a wide range of scientific disciplines such as sociology, geological sciences, text analysis, social media, medicines, public transportation and various other disciplines.

In one example, a method includes determining, by a computing device and based at least in part on information indicating a user interest, one or more items that are related to the user interest; extracting, by the computing device and from the one or more items, a set of one or more objects related to the user interest; and ordering, by the computing device, the set of one or more objects based at least in part on occurrences of each of the one or more objects within the one or more items.

In one example, a method includes generating, by a computing device and based at least in part on an input research document denoting a user's interest, a context of the user's interest, the context comprising one or more research documents from a corpus of research documents; identifying, by the computing device, one or more research datasets contained within the context; and ranking, by the computing device, the one or more datasets based at least in part on rankings of each of the one or more research documents within which each of the one or more research datasets is contained.

In one example, a method includes collecting, by a computing device, a plurality of object identifiers corresponding to respective objects, generating, by the computing device, respective contexts for the respective objects, each context comprising at least one text descriptor and at least one subject tag, and indexing, by the computing device, a database of the objects using at least the respective contexts.

In some examples, techniques of the present disclosure also address the problem of topic drift by automating removal of the noisy tags from the set of candidate new tags.

### BRIEF DESCRIPTION OF DRAWINGS

FIG. 1 is a block diagram illustrating an example computing environment in which a context-based analysis system may be configured to learn a user's interests and inform the user about items pertaining to those interests, in accordance with one or more aspects of the present disclosure.

FIG. 2 is a block diagram illustrating an example context-based analysis system in accordance with one or more techniques of the present disclosure.

FIG. 3 is a flow diagram illustrating example operations for extending a user's given interest and identifying datasets in accordance with one or more techniques of the present disclosure.

FIG. 4 is a flow diagram illustrating example operations for generating the context for a document.

FIG. 5 is a logical diagram illustrating example rank aggregation using the Borda count aggregation technique.

FIG. 6 is a flow diagram illustrating example operations for finding research datasets within a corpus of documents.

FIG. 7 is a flow diagram illustrating another example operation of finding research datasets within a corpus of documents by searching the “web.”

FIG. 8 is a flow diagram illustrating example operation for how the indexed database is searched for an input query.

FIG. 9 is a flow diagram illustrating example operations for enabling context-based search in accordance with one or more techniques of the present disclosure.

FIG. 10 is a flow diagram illustrating example operations for enabling context-based search in accordance with one or more techniques of the present disclosure.

FIG. 11 is a flow diagram illustrating example operations for enabling context-based search in accordance with one or more techniques of the present disclosure.

FIG. 12 is a block diagram showing a detailed example of various devices that may be configured to implement some embodiments in accordance with one or more techniques of the present disclosure.

FIGS. 13-16 are graphs illustrating experimental results of an embodiment in accordance with one or more techniques of the present disclosure.

FIGS. 17-19 are graphs illustrating experimental results of another embodiment in accordance with one or more techniques of the present disclosure.

### DETAILED DESCRIPTION

Techniques of the present disclosure enable a computing system or other computing device to find items of interest to a user, despite the items having little or no indexable content or metadata. For instance, the computing system generates a context of a user's interest based on information indicating the user's interest, and use the context to identify potentially relevant items and determine the relevance of the items to the user's interest. As another example, the computing system generates a searchable database of items by extracting identifiers of low content items from publicly available sources, such as the Internet, and generating contexts for the identified items. The computing system may then index the identified items in the database using the generated contexts thereby enabling users to search the database for items of interest.

By generating and leveraging context of low-content or no-content items, the techniques described herein make such items more accessible to users and more easily searchable by automated search algorithms, users, and/or entities using other search methods. That is, the techniques described herein provide better accessibility for items that have little or no indexable content or metadata by generating a context for each item.

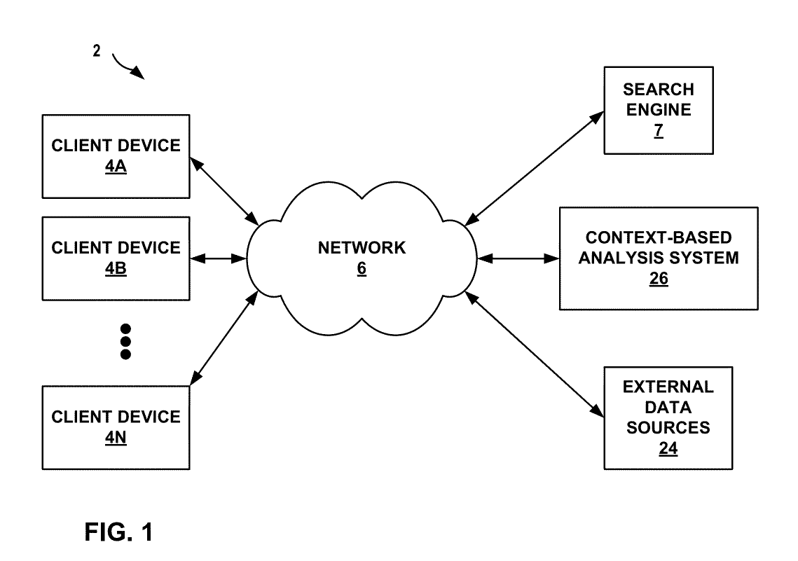

FIG. 1 is a block diagram illustrating an example computing environment in which a context-based analysis system 26 may be configured to learn a user's interests and inform the user about items pertaining to those interests, in accordance with one or more aspects of the present disclosure. In the example of FIG. 1, computing environment 2 may include client devices 4A-4N (collectively, “client devices 4”), network 6, and context-based analysis system 26. Client devices 4 may each be a computing device. Examples of computing devices include, but are not limited to, portable, mobile, or other devices such as mobile phones (including smartphones), laptop computers, desktop computers, tablet computers, smart television platforms, personal digital assistants (PDA's), server computers, mainframes, and the like. For instance, in the example of FIG. 1, client device 4A may be a tablet computer, client device 4B may be a laptop computer and client device 4N may be a smartphone. In various instances, client devices 4 may include various components for performing one or more functions such as output devices, input devices, network interface devices, and the like. For example, client devices 4 may include network interface devices for communicating with one or more networks, such as network 6.

Network 6 may represent any communication network, such as a packet-based digital network. In some examples, network 6 may represent any wired or wireless network such as the Internet, a private corporate intranet, or a public switched telephone network (PSTN). Network 6 may include both wired and wireless networks as well as both public and private networks. Context-based analysis system 26 may contain one or more network interface devices for communicating with other devices, such as client devices 4, via network 6. For example, client device 4A may transmit a request to view video content via a wireless card to a publicly accessible wide area wireless network (which may comprise one example of network 6). The wide area network may route the request to one or more components of context-based analysis system 26, via a wired connection (in this particular non-limiting example).

Context-based analysis system 26 may receive the request sent by client device 4A via network 6. Context-based analysis system 26 may, in some examples, be a collection of one or more hardware devices, such as computing devices. In other examples, context-based analysis system 26 may comprise firmware and/or one or more software applications (e.g., program code) executable by one or more processors of a computing device or a group of computing devices. In yet another example, context-based analysis system 26 may be a combination of hardware, software, and/or firmware. In some examples, one or more components of context-based analysis system 26 may perform more or other functions than those described in the present disclosure. While shown in FIG. 1 as a unitary system, context-based analysis system 26 may include various units distributed over and communicatively connected via one or more networks (e.g., network 6).

As described in further detail below, context-based analysis system 26 dynamically generates one or more content databases having descriptive content. In some examples, the content database may be separate and distinct from other components of context-based analysis system 26. In other examples, the content database may be included in one or more other components of context-based analysis system 26. In some instances, the content database may include information from one or more external data sources 24 (e.g., data systems associated with journals, industry-standard setting organizations, conferences, research institutions, Universities, etc.), each of which may be referred to below as a corpus, i.e., a collection of items.

In the example of FIG. 1, context-based analysis system 26 may communicate with search engine 7 via network 6. While shown as separate from context-based analysis system 26 in the example of FIG. 1, search engine 7 may be part of context-based analysis system 26. That is, in some examples, search engine 7 may be external to context-based analysis system 26 (e.g., one or more external data sources) and connected to context-based analysis system 26 in other ways, such as via network 6. Search engine 7 may include hardware, firmware, software, or any combination thereof capable of receiving search queries, performing searches, and/or returning results. In some examples, search engine 7 may search one or more databases, such as corporate databases, knowledge bases, or other information repositories. Such databases or information repositories may be included in search engine 7 or separate and apart from search engine 7, in various examples. In other examples, search engine 7 may perform searches of one or more networks, such as the Internet. For instance, search engine 7 may be a corporate search engine capable of performing searches based on one or more structured queries using a query language (e.g., Structured Query Language), a search algorithm built for a specific database, or a commercial search engine capable of crawling, indexing, and searching web content.

In some examples, context-based analysis system 26 generates a context of a user's interest based on information indicating the user's interest, such as the title of an identified research document, the authors of a document, or the like. Context-based analysis system 26 then uses the generated context to identify potentially relevant items of interest, such that it may determine the respective level of relevance for each of the potentially relevant items with respect to the user's interest. Furthermore, the context-based analysis system 26 may generate a searchable database of content (i.e., items) by extracting identifiers of low content items from external data sources 24 and generating contexts for the identified items. Context-based analysis system 26 may then index the identified items in the database using the generated contexts thereby enabling users to search the database for items of interest.

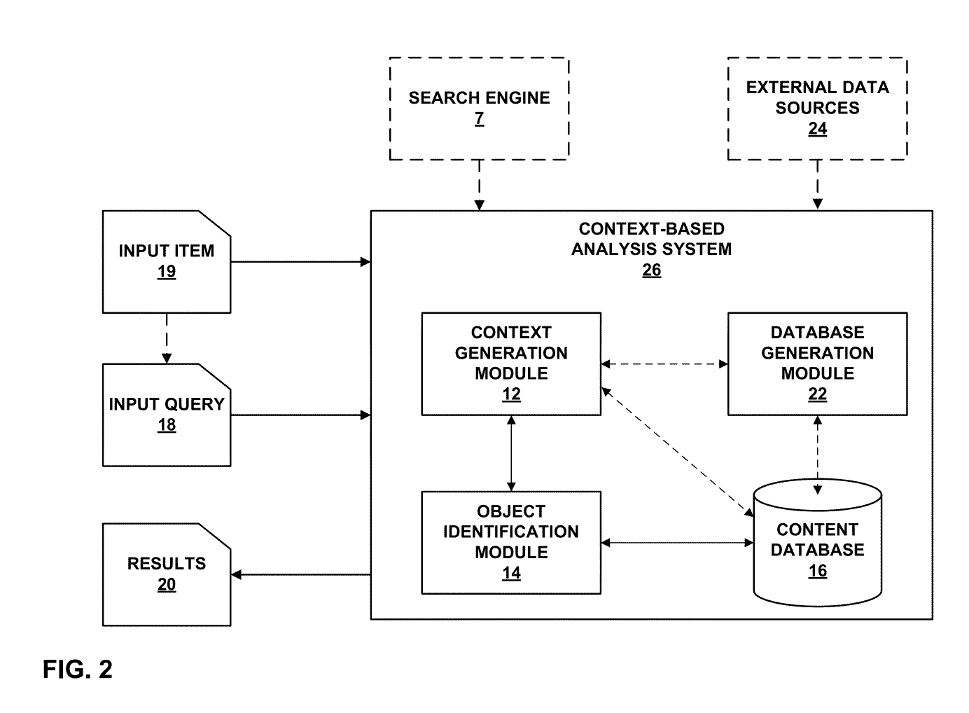

FIG. 2 is a block diagram illustrating an example context-based analysis system 26 (“system 26”) in accordance with one or more techniques of the present disclosure. In the example of FIG. 2, system 26 may represent a computing device or computing system, such as a mobile computing device (e.g., a smartphone, a tablet computer, and the like), a desktop computing device, a server system, a distributed computing system (e.g., a “cloud” computing system), or any other device capable of performing the techniques described herein. In accordance with the techniques described herein, system 26 enable users to search for items with little or no metadata and/or indexable content, such as research datasets. System 26 receives an input query, such as query 18, and provides relevant results (e.g., results 20).

As shown in the example of FIG. 2, system 26 includes context generation module 12, object identification module 14, and content database 16. In some examples, system 26 may also include database generation module 22. Each of modules 12, 14, and 22 may be hardware, firmware, software, or some combination thereof. Content database 16 may, in the example of FIG. 2, represent a data repository or other collection of information that is accessible and/or modifiable by one or more of modules 12, 14, and 22.

In some examples, object identification module 14 may be operable to identify objects within external data source 24. In addition, object identification module 14 may be operable to search the Internet or other networks for objects (e.g., items) via search engine 7 for example. In other examples, object identification module 14 may be operable to search documents stored within content database 16 to determine items or objects (e.g., research datasets) of interest.

Context generation module 12, in the example of FIG. 2, may be operable to receive a query (e.g., input query 18) or an item (e.g., input item 19), and generate a context accordingly. For example, system 26 may receive input item 19 indicating an interest of the user. In some examples, input item 19 may indicate an item (e.g., research document), or an identifier for an item such as a universal resource locator (URL). An item, in general, may be a file, an object, a data structure, or any other collection of information. Examples of items include text documents (e.g., research papers, dissertations, white papers, journal articles, books, magazines, news articles, and the like), multimedia files (e.g., images, audio files, video files, movies, TV shows, songs, audiobooks, and other media), collections of data (e.g., databases, research datasets, lists, multidimensional datasets, and the like), and others. In other words, an item may be any arrangement of information.

In other examples, input query 18 may be a keyword search. For example, input query 18 may be a structured query using a query language, such as Structured Query Language. In other examples, input query may be a natural language search query or a Boolean search query using Boolean operators (e.g., AND, OR, NOT, etc.). In some examples, input query 18 may be based on information derived from input item 19.

In the example of FIG. 2, system 26 may generate various contexts in order to determine objects (e.g., research datasets) that are relevant to the user's interests, as specified by input item 19. As one example, if input item 19 is a text document, such as a research paper, context generation module 12 may generate a context for the item based on a title of the research paper. Additionally or alternatively, context generation module 12 may generate the context based on an author of the item, on a portion of the item's content (e.g., an abstract or summary), on the entire content of the item, or on any other information. As another example, input item 19 may previously be annotated with metadata (e.g., tags). In such instance, context generation module 12 generates the context for input item 19 based at least in part on the previous annotations. That is, in various examples, context generation module 12 uses various different types of available information to generate a context for input item 19.

In some examples, context generation module 12 extends the initially identified context (e.g., title, abstract, author, etc.) by leveraging external data sources 24 and conducting similarity computations. For example, context generation module 12 extends the context for a research paper by ranking items in an identified external data source 24. In some examples, context generation module 12 computes a content based similarity measurement using the title and/or the abstract of an input item 19. In other examples, context generation module 12 computes an author based similarity measurement using only the one or more author's names of input item 19. In some instances, context generation module 12 computes and combines both the author based similarity measurement and the content based similarity measurement using ranking aggregation techniques.

In a non-limiting example, one or more modules of system 26 create and/or maintain content database 16. For instance, object identification module 14 identifies items (e.g., datasets) from one or more external data sources 24 in accordance with one or more techniques of the present disclosure. For example, object identification module 14 may perform automated extraction techniques or web scraping techniques. Database generation module 22 then generates a context for the identified items (e.g., datasets) in order to construct and/or maintain content database 16. Although shown in FIG. 2 as a single entity, content database 16 may be comprised of one or more separate databases. In addition, each module described herein is not limited to its respective function. For example, database generation module 22 may perform the functions associated with object identification module 14 and likewise, the functions associated with context generation module 12, or any combination thereof.

Furthermore, in the example of FIG. 2, system 26 may receive an input query 18 (e.g., natural language search query, information about input item 19) with which object identification module 14 can use to locate one or more candidate items within content database 16. System 26 performs a relevance search with respect to the input query 18, and outputs results 20 based at least in part on the results of the search. Accordingly, the results 20 indicate relevant objects with respect to a user's identified interest or a ranking of items pertaining to the user's identified interest. In this way, system 26 may leverage context generation to enable search for objects that have little or no indexable content.

As discussed in various examples herein, techniques of the present disclosure enable system 26 to extend the context of an identified user's interest based on information about an input item 19 (e.g., a document, video or other item) by leveraging external data sources 24 within network 6. In addition, context generation module 12 generates a context for a plurality of datasets collected from external data sources 24 wherein the datasets are collected through the use of techniques such as automated extraction and/or web scraping. Context generation module 12 dynamically generates content database 16 based at least in part on the generated context for the plurality of datasets collected. As such, content database 16 comprises a broader collection of data that represents the context for such datasets.

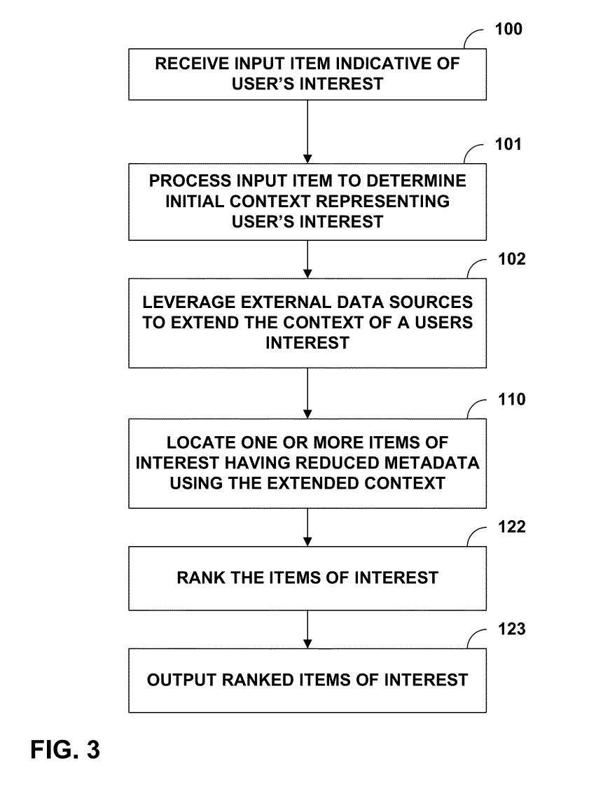

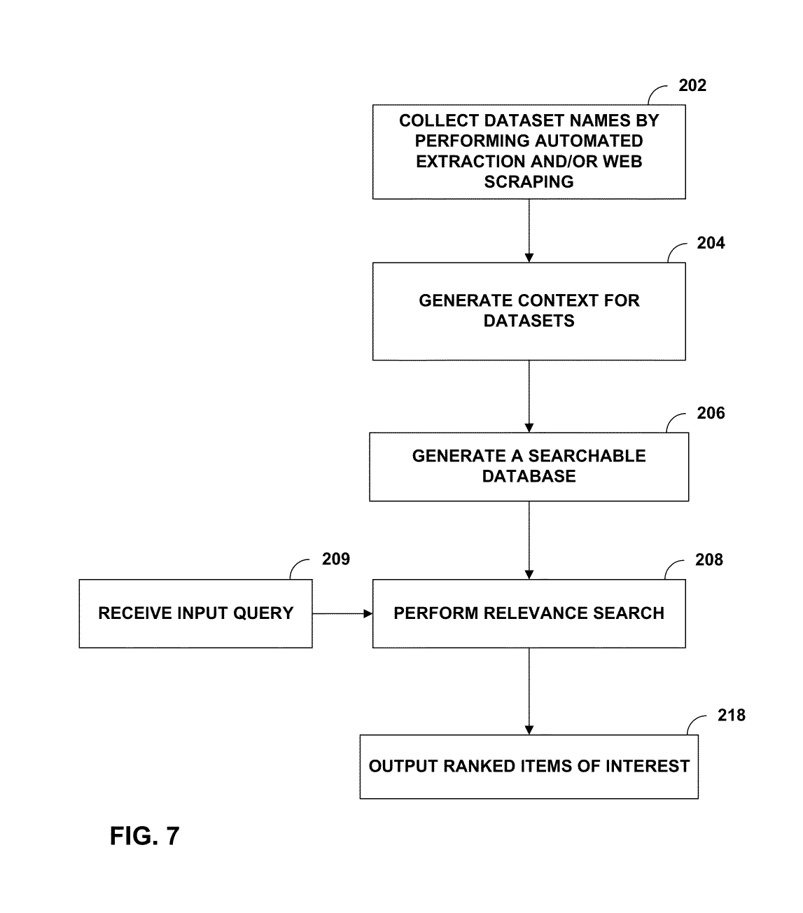

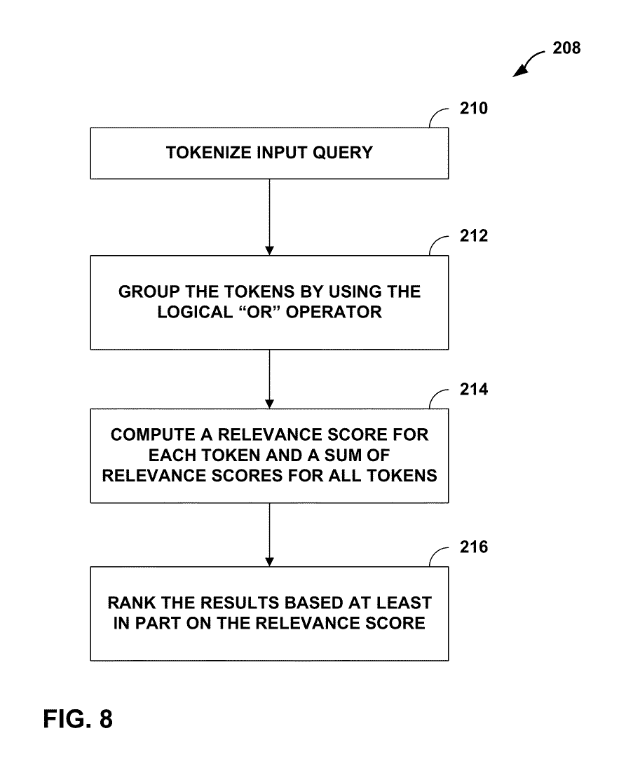

As further described below in references to FIGS. 3-8, users may interact with context-based analysis system 26 to locate items of interest (e.g., research datasets) having reduced or minimal content (e.g., metadata). For example, a user presents or otherwise identifies an input item 19 that is assumed to be representative of the user's interest. As one example, the user may upload a research paper indicative of the user's interest. Context generation module 12 then processes the document to extend the context of the user's identified interest. Next, object identification module 14 locates, based at least in part on the extended context, items of interest (e.g., results 20) from the one or more external data sources 24, the content database 16, or both. Alternatively or additionally as further described below in references to FIGS. 7-8, a user may present an input query 18 specifying an item of interest. Likewise, object identification module 14 then locates items of interest from, for example, a searchable content database 16 generated in accordance with techniques described herein.

FIG. 3 is a flow diagram illustrating example operations for extending a user's given interest and identifying datasets in accordance with one or more techniques of the present disclosure. As described previously, techniques are described for identifying datasets in the absence of metadata information about an item of interest. The example of FIG. 3 derives metadata information about an item of interest by extending a user's given interest. For purposes of illustration only, the example operations of FIG. 3 are described below in reference to context-based analysis system 26 of FIGS. 1 and 2. In the first instance, system 26 receives an input item 19 (e.g., research document) indicative of the user's interest (100). For example, the user's interest (i.e., the initial context) may be denoted by information associated with the input item (e.g., the title, author's, abstract, etc.). Accordingly, context generation module 12 processes input item 19 and the information associated with input item 19 in order to determine an initial context representing the user's interest (101).

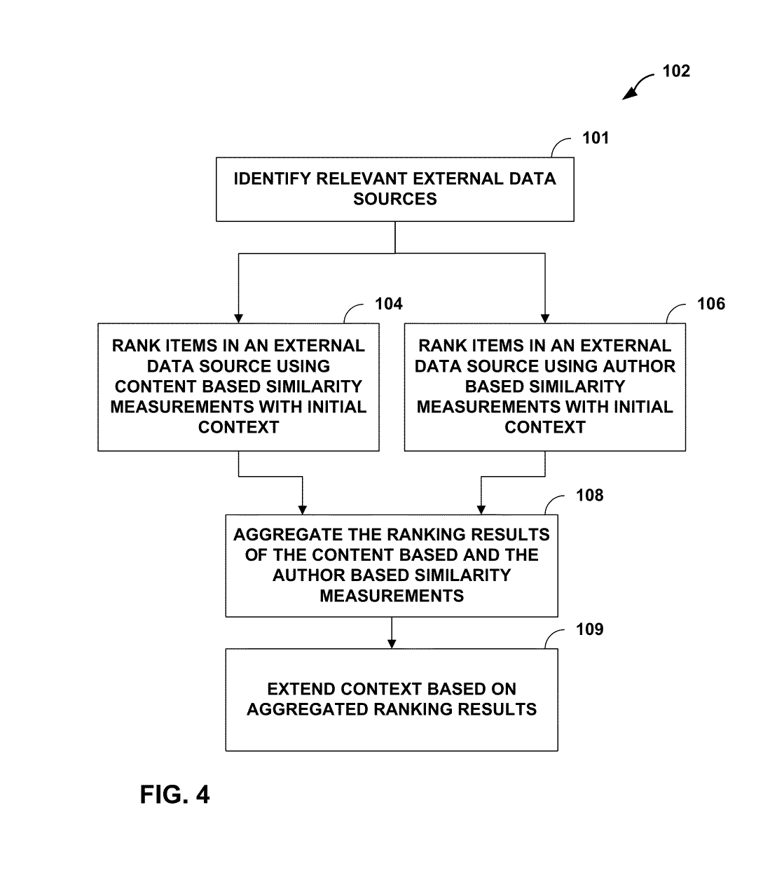

In the example of FIG. 3, system 26 operates to extend the context of a user's interest based at least in part on a ranking of content located in one or more external data sources 24 (102). As one example, context generation module 12 may generate a context for an item specified by input item 19, such as a research paper or other document indicating the interest of a user. In such example, context generation module 12 may generate a context based at least in part on information about the document. For instance, context generation module 12 may use a title and/or an author of the document. Additionally or alternatively, context generation module 12 may generate the context based on a portion of the document's content (e.g., an abstract or summary), on the entire content of the document, or on any other information. As another example, context generation module 12 may generate a context for an object identified by object identification module 14. In such example, context generation module 12 may generate a context for the object based on a title or name of the object. For instance, context generation module 12 may generate a context for a research dataset identified by object identification module 14 based on the name of the research dataset. In other words, in various examples, context generation module 12 may use various different types of available information about items and/or objects to generate contexts for the items and/or objects. Ultimately, an extended context for user's interest is created using a corpus of research documents. The documents which are more relevant to a user's interest are ranked higher in the corpus (102). Further details are discussed below with respect to FIG. 4 describing an example process (i.e., author based and content based similarity computations) by which context generation module 12 may extend the context of a user's interest based on the identified initial context.

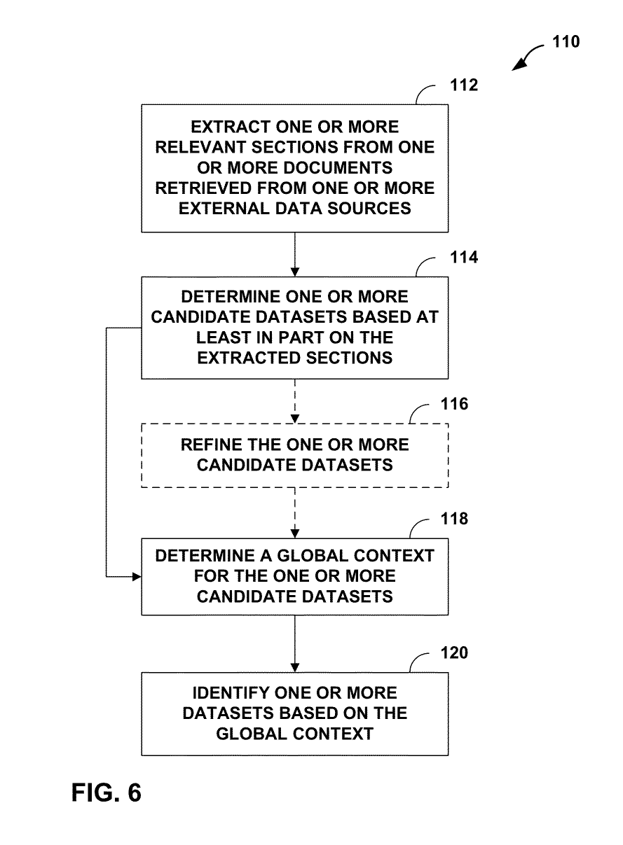

Returning to the example of FIG. 3, system 26 identifies one or more datasets based at least in part on the extended context (110). For example, object identification module 14 may be operable to identify objects within a corpus of items. For instance, object identification module 14 may be operable to search documents stored within content database 16 to determine research datasets or other objects mentioned in the documents. As another example, object identification module 14 may be operable to search (e.g., query) network 6 via search engine 7 or external data sources 24 for potential objects of interest. Further details are discussed below with respect to FIG. 6 describing an example process by which object identification module 14 locates items of interest using the extended context.

Returning to the example of FIG. 3, object identification module 14 may then rank the final set of object names in order of relevance to the user's interest (e.g., as specified by a document identified in input item 19) based on the extended context previously determined (122) after having identified items based on the extended user's interest. Finally, object identification module may output the ranked items of interest (123) for further processing (e.g., displaying to the user) by one or more client devices 4.

Using an exponentially decaying function for ranking may have several advantages. For example, using the exponentially decaying function increases the score of datasets (or item) if the datasets are used in documents which are highly ranked in the extended context for the user. In another example, the scores of a dataset increases if the dataset is used frequently. For instance, system 26 may determine the rank for an object by summing (in a negative exponential manner) the ranks of all documents (specified by the context) which include the object as follows:

R(Dᵢ)=Σexp^{(-xj)}

where, R(Dᵢ) is the rank for dataset dᵢ and x is the rank of the document dᵢ in which Dᵢ is used.

FIG. 4 is a flow diagram illustrating example operations for generating the context for a document (e.g., specified by input item 19) using the document title, author, or both. For example, context generation module 12 generates the context for a document (e.g., specified by input item 19) using the document title and author. In order to generate metadata for items so that it may be used for recommendations, the context of user's interest is extended consistent with techniques described herein. As such, a user's interest is assumed to be denoted by an item (e.g., research document) wherein the user's interest is derived from the basic ingredients (i.e., information) associated with the input item (e.g., the topic of the document, the abstract summary, author's names, etc.). With this information, the context of a user's interest can be created and extended by using an external corpus consisting of research documents. In other words, the context may be extended by finding documents which are related to a user's identified interest.

FIG. 4 describes one way of generating a context for a research paper by finding documents that are related to the input document. Context generation module 12 may determine document relatedness based on a combination of content based similarity and author based similarity. In other words, document relatedness may be measured using a content based similarity approach, an author based similarity approach, or a combination of both. Accordingly, object identification module 14 first identifies one or more relevant external data sources 24 (101) with which the contents (e.g., data) will be used to extend the context of a user's interest.

In the example of FIG. 4, the content based similarity approach compares the similarity (i.e., relatedness) between two documents and rank the documents based on similarity (104). In order to compare the one or more documents in the corpus with the document topic and abstract summary in a user's interest, for example, a TF-IDF model may be used to create TF-IDF vector representation of each document. As such, standard natural language preprocessing (e.g., stop-word removal, special character removal, etc.) may be done as the first step. The similarity comparison between the TF-IDF vectors of two documents may be done using cosine similarity metric. For example, the documents in the research corpus may be ranked in order of their respective cosine similarity with a user's interest. For instance, a document with a lower cosine similarity score may receive a higher rank.

In other words, context generation module 12 may determine content-based similarity by generating a vector for the input document and determining a cosine similarity measure between the vector representing the input document and vectors representing other documents from a corpus (e.g., documents within content database 16). Each vector may represent the semantic makeup of the respective document. That is, context generation module 12 may generate a vector for the document specified by input item 19 that reflects how important each word in the document is within a corpus of documents. For instance, context generation module 12 may generate a Term Frequency-Inverse Document Frequency (TF-IDF) vector for the document specified by input item 19 that includes a value for each word in the document. The value increases proportionally to the number of times the word occurs in the document, but the value is offset by the frequency of the word in the corpus of all documents. In other examples, context generation module 12 may generate other types of semantic representations, such as a Latent Dirichlet Allocation TF-IDF (LDA-TFIDF) vector, or a Latent Semantic Indexing TF-IDF (LSI-TFIDF) vector, or any other representation usable to compare the semantic makeup of two documents.

Alternatively and using information about one or more author's names, context generation module 12 may determine author based similarity based on web-distance metric (e.g., the minimum normalized Google distance) (106). That is, for each document in the corpus (e.g., in content database 16), context generation module 12 ranks the document based on the minimum normalized Google distance between authors of the document specified by input item 19 and authors of the corpus document.

For example, the names of the authors may be used to extend the context of the user's interest. In the author based similarity measurement, the one or more documents in the corpus (C) are ranked based on the minimum normalized Google distance (NGD) between authors' information in user's interest and the authors of the documents in the corpus (C). The documents in the corpus are ranked using the following metric:

sim(d_{I},dⱼ)=min(NGD(Aₖ^{I},Aₗ^{j}))

where, d_{I} is the document in user's interest, Aₖ^{I} denotes the k^{th} author in the user's interest I, Aₗ^{j} denotes the l^{th} author of the j^{th} document in the corpus, NGD is the Normalized Google distance function.

The normalized Google distance (NGD) between two words is defined as follows:

$$NGD ( x , y ) = \frac{max \{ log f ( x ) , log f ( y ) \} - log f ( x , y )}{log M - min \{ log f ( x ) , log f ( y ) \}}$$

where M is the total number of web pages searched by the search engine, f (x) and f (y) are the number of hits for search terms x and y, respectively, and f (x, y) is the number of web pages on which both x and y occur.

For example, if the two search terms x and y never occur together on the same web page, but do occur separately, the normalized Google distance (NGD) between them is infinite. Alternatively, if both terms always occur together, the NGD between them is zero, or equivalent to the coefficient between x squared (i.e. x²) and y squared (i.e. y²).

As shown in FIG. 4, context generation module 12 ranks each document in the corpus (e.g., in content database 16) based on its content based similarity to the input document, its author based similarity to the input document, or both. For instance, context generation module 12 may employ the Borda rank aggregation technique, or other techniques to generate a single metric of which the corpus of documents can be ranked (108). In other words, as described above, context extension for user's interest may be done by first ranking documents in the corpus based on the ranking results of both ranking approaches described previously (i.e., using only the content information from user's interest and using only the author information from user's interest).

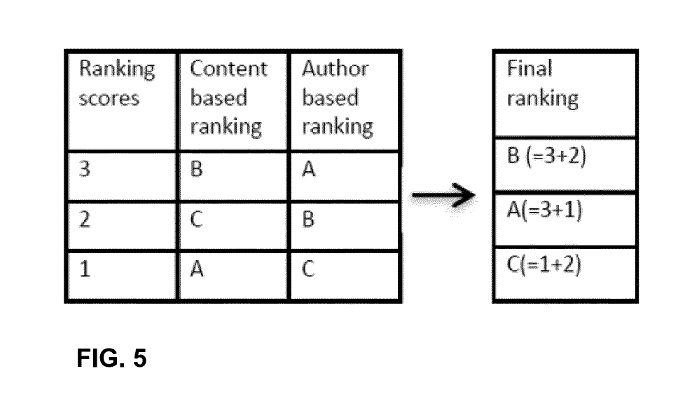

For example, if both ranking approaches are used, the two ranks for each document in the corpus may be aggregated using the Borda rank aggregation technique as described in reference to FIG. 5 below. As such, rank aggregation approaches are helpful to account for both content based ranking and author based ranking. In other words, a single metric to rank the documents in the corpus based on the full information of user's interest may be obtained using the approach outlined in more detail below. The overall ranking of the corpus of documents may serve as the extended context for the document specified by input item 19 (109). That is, the context for the input document may be an ordered set of the documents in the corpus, ranked in order of relatedness to the input document based on a combination of content based similarity and author based similarity.

FIG. 5 illustrates the rank aggregation mechanism using a simple example. In FIG. 5, the final rank for document ‘A’ is obtained by adding the two scores attributed to ‘A’ by the content based similarity and the author based similarity. As shown in FIG. 5, the final score for ‘A,’ ‘B,’ and ‘C’ are 4, 5 and 3, respectively. Hence, the final order of the documents after aggregation is B>A>C.

As described above in the example of FIG. 3, object identification module 14 may be configured to locate items having reduced metadata using the extended context as generated by context generation module 12. In some instances, the context or the metadata information around the items (i.e., datasets) of interest is not explicitly available. In this case, context generation module 12 generates a context for an object, such as a research dataset specified by object identification module 14. For example, context generation module 12 may generate a context for an object by searching one or more academic databases using an identifier of the object, such as a name of the object or object title. Since the database used by academic search engines consists of research articles, scholarly reports, and other scientific documents, context generation module 12 can use these items to create the context for an object based on the assumption that objects (e.g., research datasets) are referred to in at least some items of the database by, for instance, certain names. Thus, context generation module 12 may query the database using an object name and generate the context for the object from the received results. Context generation module 12 may use the titles of the top results (e.g., the top fifty results, the top ten results, or other value) to form a title text context and use subject tags of the top results to form a subject tag context.

FIG. 6 is a flow diagram illustrating example operations for finding research datasets within a corpus of documents (e.g., the context of an input document generated by context generation module 12). FIG. 6 illustrates an example of step 110 of FIG. 3 in further detail. As described before, the context creation is done by extending the user's interest using an external research corpus. An algorithmic approach for item identification from the extended context of a user's interest may be used, as shown in FIG. 6. The approach is based on identification of the item of a particular category (i.e., datasets). As described in FIG. 6, object identification module 14 may use natural language processing techniques to extract names of research datasets from the documents (112). For instance, for each document, object identification module 14 extracts the relevant section (e.g., an experimental section) from the document. As such, dataset (i.e., item of interest) descriptions are assumed to appear in certain well defined sections of a document. Standard parsing techniques are used to extract the sections in which the experimental setup is described. For example, a research document may be obtained in a PDF format from the “web” and then converted to text format for parsing and extraction. For example, the relevant sections (e.g., experimental section, dataset description sections, etc.) may be extracted by text parsing using root terms (e.g., “Experiment,” “Analysis,” “Evaluation,” “Data,” etc.) in order to identify and extract sections of interest from the text files of the research documents. Context generation module 12 then determines one or more candidate datasets based at least in part on the extracted sections (114).

As described in FIG. 6, object identification module 14 may refine the one or more candidate datasets using natural language processing techniques or a language knowledge base (e.g., Thesaurus), or both (116). For example, object identification module 14 may parse the extracted sections using natural language processing to remove stop words, special characters, and/or other extraneous text. Next, object identification module 14 extracts, from the processed language, candidate words having the same sentence structure property as the item of interest (e.g. noun, verb, etc.). For instance, to identify candidate research datasets, only words which are nouns may be extracted. In some examples, only words beginning with capital letters may be considered candidates, as the objects may have proper names. Object identification module 14 may evaluate each candidate object name using a language knowledge base, such as a thesaurus. That is, object identification module 14 performs outlier selection to determine those candidate object names that are not used in common English language practice, as these may be less likely to be object identifiers.

In the example of FIG. 6, once the candidate datasets are determined and/or refined as described above, context generation module 12 may generate a “global context” for the candidate datasets using web intelligence (e.g., by using search engine 7). In other words, in order to determine the final set of object names, context generation module 12 generates a web query using each candidate object name and an indication of the type of object sought (e.g., “data”) and performs a search using search engine 7 (e.g., Google Scholar™) (118). In response to the query, search engine 7 may return information related to the search query. For example, search engine 7 may return a list of document titles and, in some instances, “snippet” texts. As a result, context generation module 12 generates the context based in part on the information received from search engine 7 in response to the search query. For example, a query may be a combination of the candidate term and the term “data.” Given the query of the form [dᵢ data], search engine 7 returns top-k results for the query. In addition to the document titles, search engine 7 (e.g., Google Scholar™) may provide information about context from the document where the terms appear (i.e., “snippets”).

As a result, context generation module 12 may select the final set of object names by determining, for each candidate object name, whether the frequency of occurrence, within the title and/or snippets of the top-k results (e.g., the top ten results, the top fifty results, or some other number) of the query, of the candidate object name appearing adjacent to the object type, exceeds a threshold value (120). A threshold value may be determined by optimizing an F₁-measure value using precision and recall variation over different values of the threshold value. In some examples, context generation module 12 may store all results of the search, while in other examples, context generation module 12 may store only the most relevant results (e.g., the top result, the top five results, or other number of results) to identify the frequency of the candidate term appearing adjacently to the term “data.” Object identification module 14 may then identify a plurality of dataset names from the candidate set based on the “global context.” For example, several forms of adjacency may be considered (e.g., first left neighbor, second left neighbor, first right neighbor, second right neighbor, etc.). As such, context generation module 12 determines the frequency of each positioning from the top-k results which yields a frequency distribution of various positioning at which the item category (i.e., data) appears with respect to the candidate word (i.e., dataset name). In other examples, object identification module 14 may perform the task of selecting the top-k results of the query in response to context generation module 14 performing the search query or any combination thereof.

In other words, for a candidate object name, object identification module 14 determines the number of times that the candidate object name occurs adjacent to the specified object type (e.g., “data”) within the title and snippet of the top results. If the number of times exceeds the threshold, then the candidate object name is added to the final set of object names. In some examples, the adjacency of the candidate object name and object type is specific. For instance, in some examples, object identification module 14 may determine the number of times that the candidate object name occurs immediately to the left of the specified object type. Furthermore, out of all the possible positions described above, the position of first right neighbor has been found to be the most important position for such purposes. Therefore, object identification module 14 may identify the final dataset names based on the first right neighbor frequency of the candidate name with the term “data.”

As further described below in references to FIGS. 7-8, users may interact with context-based analysis system 26 to locate items of interest (e.g., research datasets) having reduced or minimal content (e.g., metadata). Context generation module 12 generates a context for a plurality of datasets collected from external data sources 24 wherein the datasets are collected through the use of techniques such as automated extraction and/or web scraping. Context generation module 12 dynamically generates content database 16 based at least in part on the generated context for the plurality of datasets collected. As such, content database 16 comprises a broader collection of data that represents the context for such datasets. A user may present an input query 18 specifying an item of interest. Likewise, object identification module 14 then locates items of interest from, for example, a searchable content database 16 generated in accordance with techniques described below.

FIG. 7 is a flow diagram illustrating another example operation of object identification module 14 finding research datasets within a corpus of documents by searching the “web,” and compiling the datasets into a searchable database Accordingly, an identifier may be necessary such that a particular resource in a database may be represented accurately. As such, the identifier may be a title or the name of the resource indexed in a database. In another example, the research datasets may be represented by a reference name (i.e., the names by which the datasets are referenced in other research articles).

As shown in FIG. 7, object identification module 14 may perform automated extraction and/or web scraping to determine object names (202). For instance, object identification module 14 may perform natural language processing techniques and co-occurrence information from the web to identify object (i.e., dataset) names. In other words, dataset names from documents are extracted by leveraging the description of datasets in those documents. Alternatively, object identification module 14 may extract object names from the web via automated crawlers and scrapers. For example, dataset names may be collected from various data repositories open sourced over the “web.” As such, the database should consist of datasets used in diverse research areas (e.g., climate data, sensor data, medical data, finance data, etc.). In some examples, object identification module 14 may obtain other metadata or information about the objects, such as a URL at which the object name was found, and/or a description of the object. Furthermore, and as described in previous paragraph(s), context generation module 12 may generate a context for one or more objects, such as a research dataset specified by object identification module 14 (204).

In some examples, database generation module 22 of system 26 may use the obtained object names and generated context of each object to generate a searchable database of objects. That is, in some examples system 26 may use a general corpus of documents to find objects of interest to a user while in other examples, system 26 may generate a specialized database for use in finding objects of interest to the user. In one example, database generation module 22 generates and indexes such a specialized database.

In the example of FIG. 7, database generation module 22 may store objects specified by object identification module 14, and index the objects using information from the context of the object, as generated by context generation module 12 in order to create a searchable content database 16 (206). For instance, database generation module 22 may index each object using (1) any descriptive information for the object that was scraped from the web by object identification module 14, (2) the title text context generated by context generation module 12, and (3) the subject tag context generated by context generation module 12. The name of the dataset may also be indexed, but, due to its minimal text content, would most likely not contribute significantly to the index. The three content types used in indexing are referred to as different fields of the dataset wherein each field is indexed separately. For example, there may be a separate index for the author's description, a separate field for the title based “context,” and a separate index for the subject tags. While the owner's description and the title-based “context” are indexed as text fields, the subject tags are indexed as full keywords. In order to create indexes to include different morphological variants of the words, an N-gram parser may be used for each word. For example, the text content in each of the fields may be tokenized using the space tokenizer. Each token is then expanded in the different N-grams. In addition, the minimum window size and maximum window size used for N-gram generation may be set accordingly.

In the example of FIG. 7, system 26 receives an input query 18 with which object identification module 14 then searches the indexed content database 16 based on the input query 18 (208). In other words, given a user query for a dataset, a search for relevant datasets may be performed. Further details are discussed below with respect to FIG. 8 describing an example process by which object identification module 14 performs a relevance search based on an input query 18. Once the relevance search is complete, system 26 outputs the items of interest ranked in order of relevance to the input query 18 as results 20 (218).

FIG. 8 is a flow diagram illustrating example operation for how the indexed content database 16 is searched for a given input query. First, input query 18 is tokenized, for example, using a space delimiter (210). Each token in the query is used to search datasets in the database. The tokens in the query are grouped by the logical ‘OR’ operator with a higher precedent to number of token matches than to the frequency of a single token (212). For example, the input query may be “foo bar” wherein two matches are returned. One of the matches containing the token “foo” five times and the second result containing both the tokens “foo” and “bar.” Therefore, it is expected that the result containing both the term “foo” and the term “bar” should get a higher score than the one with high frequency of the term “foo.” Moreover, if the datasets are indexed by multiple fields, then each of the tokens in the query should also be searched in the indexes of all the fields. The multi-fields in the database are utilized by OR-ing the token for each field. For example, for search query “climate prediction data,” the query should be parsed in the following manner:

OR([OR([Term(‘title’,u‘climate’),Term(‘des’,u‘climate’),
Term(‘cxt’,u‘climate’),Term(‘tags’, u‘climate’)]),
OR([Term(‘title’,u‘prediction’),Term(‘des’,u‘prediction’),
Term(‘cxt’, u‘prediction’),Term(‘tags’,u‘prediction’)]),
OR([Term(‘title’,u‘data’),Term(‘des’,u‘data’),Term(‘cxt’,u‘data’),
Term(‘tags’,u‘data’)])])

where “title,” “des,” “cxt,” and “tags” are the dataset name, dataset description, title-based “context” and subject tag fields, respectively, in the database. For each token, an algorithm (e.g., BM25 algorithm) may compute a relevance score. Since each of the tokens are grouped by “OR” and the search over each of the fields is also grouped by “OR,” the OR grouping is converted to a mathematical addition of the scores for search results for each token as computed by the algorithm. The final relevance score for results 20 is computed as a sum of relevance scores for each term in the indices of the result (214). The results 20 may be then ranked in decreasing order based at least in part on the relevance score (216).

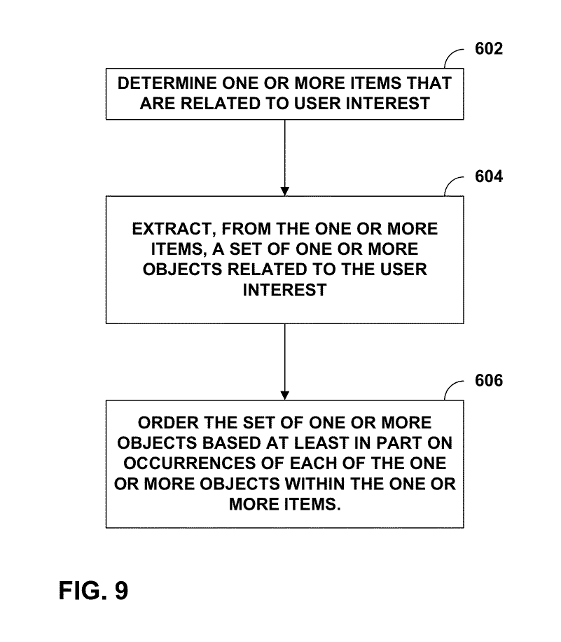

FIG. 9 is a flow diagram illustrating example operations for enabling context-based search in accordance with one or more techniques of the present disclosure. For purposes of illustration, the example operations of FIG. 9 are described below within the context of FIGS. 1 and 2.

In the example of FIG. 9, system 26 may determine, based at least in part on information indicating a user interest, one or more items that are related to the user interest (602). System 26 may extract, from the one or more items, a set of one or more objects related to the user interest (604). System 26 may, in the example of FIG. 9, the set of one or more objects based at least in part on occurrences of each of the one or more objects within the one or more items (606).

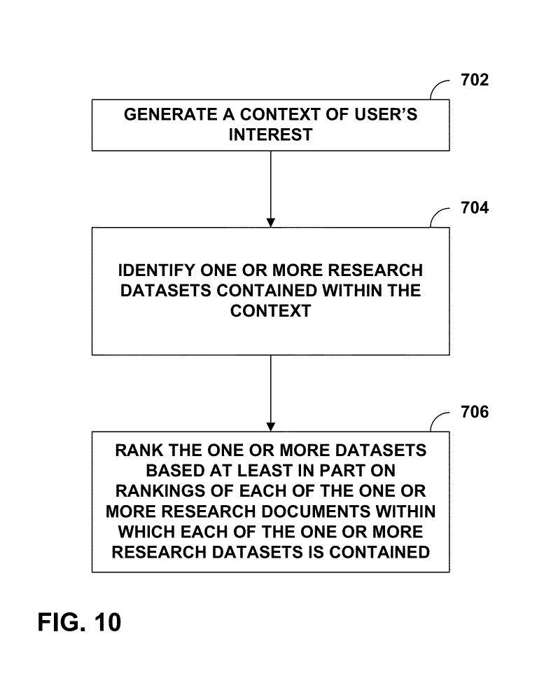

FIG. 10 is a flow diagram illustrating example operations for enabling context based search in accordance with one or more techniques of the present disclosure. For purposes of illustration only, the example operations of FIG. 10 are described below within the context of FIGS. 1 and 2.

In the example of FIG. 10, system 26 may generate, based at least in part on an input research document denoting a user's interest, a context of the user's interest (702). The context may include one or more research documents from a corpus of research documents.

System 26, in the example of FIG. 10, may identify one or more research datasets contained within the context (704). System 26 may rank the one or more datasets based at least in part on rankings of each of the one or more research documents within which each of the one or more research datasets is contained (706).

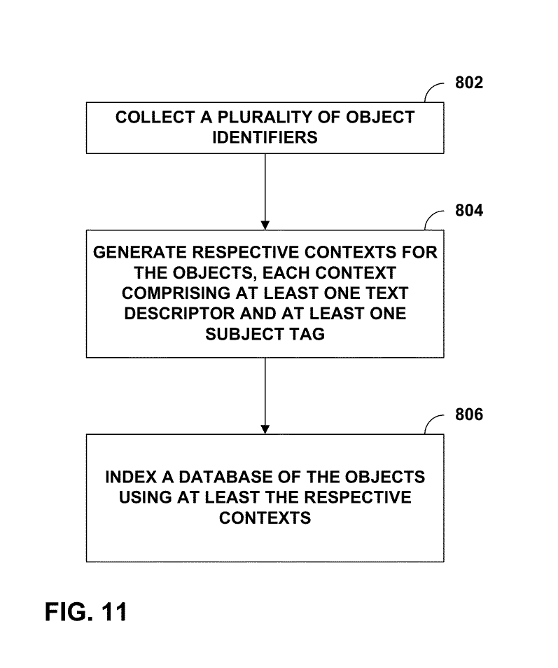

FIG. 11 is a flow diagram illustrating example operations for enabling context-based search in accordance with one or more techniques of the present disclosure. For purposes of illustration only, the example operations of FIG. 11 are described below within the context of FIGS. 1 and 2.

In the example of FIG. 11, system 26 may collect a plurality of object identifiers corresponding to respective objects (802). System 26 may generate respective contexts for the objects (804). Each context may comprise at least one text descriptor (e.g., title text) and at least one subject tag. System 26 may then, in the example of FIG. 11, index a database of the objects using at least the respective contexts (806).

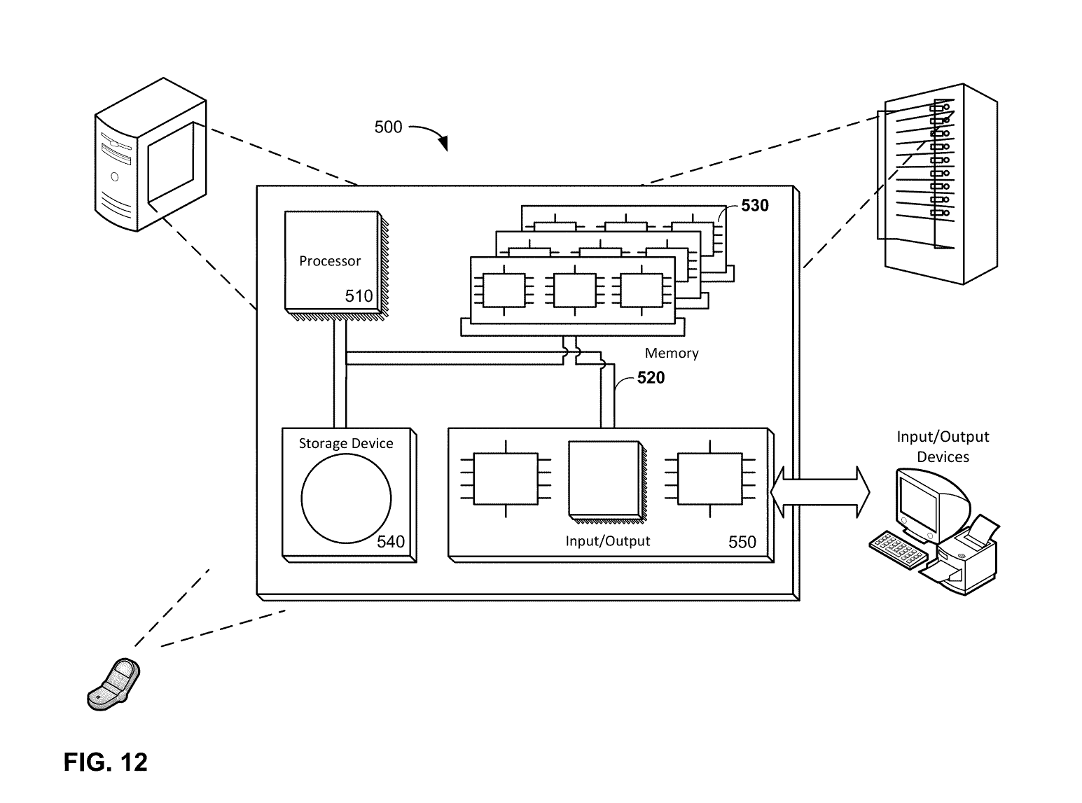

FIG. 12 is a block diagram showing a detailed example of various devices that may be configured to implement some embodiments in accordance with one or more techniques of the present disclosure. For example, device 500 may be a laptop computer, a mobile device, such as a mobile phone or smartphone, a workstation, a computing center, a cluster of servers or other example embodiments of a computing environment, centrally located or distributed, capable of executing the techniques described herein. Any or all of the devices may, for example, implement portions of the techniques described herein for generating and/or analyzing contexts for improved search functionality.

In the example of FIG. 12, a computer 500 includes a processor 510 that is operable to execute program instructions or software, causing the computer to perform various methods or tasks, such as performing the techniques for searching for relevant objects using context as described herein. Processor 510 is coupled via bus 520 to a memory 530, which is used to store information such as program instructions and other data while the computer is in operation. A storage device 540, such as a hard disk drive, nonvolatile memory, or other non-transient storage device stores information such as program instructions, data of the content database, and other information. The computer also includes various input-output elements 550, including parallel or serial ports, USB, Firewire or IEEE 1394, Ethernet, and other such ports to connect the computer to external devices such a printer, video camera, surveillance equipment or the like. Other input-output elements include wireless communication interfaces such as Bluetooth, Wi-Fi, and cellular data networks.

The computer itself may be a traditional personal computer, a rack-mount or business computer or server, or any other type of computerized system. The computer, in some examples, may include fewer than all elements listed above, such as a thin client or mobile device having only some of the shown elements. In another example, the computer is distributed among multiple computer systems, such as a distributed server that has many computers working together to provide various functions.

In one or more examples, the functions described herein may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media, which includes any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable storage medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

### Experimental Results

This section describes the experimental design used to evaluate the performance of techniques described herein as illustrated by FIGS. 3-6. In this first experiment, the main experiment was divided into two sets of sub-experiments, and was performed in order to evaluate the disclosed approach as illustrated by FIGS. 3-6. The first set of experiments was conducted in order to evaluate the performance of the item finding algorithm disclosed herein. The second set of experiments was conducted to evaluate the performance of the overall item ranking approach disclosed herein.

In this first set of sub-experiments, four-hundred research documents from the DBLP bibliography corpus were used which were published in important data mining venues, such as KDD, ICDM, CIKM and WWW. The full research documents were obtained in their pdf versions from the “web” and then converted to text format for subsequent parsing and extraction. The relevant sections like experimental sections or dataset description sections were extracted by text parsing using root terms (e.g., “Experiment,” “Analysis,” “Evaluation,” “Data,” etc.) in order to identify and extract sections of interest from the text files of the research documents. The extract of relevant sections from these 400 documents served as the input for the disclosed item finding algorithm.

The ground truth for the dataset names were extracted from the four-hundred research documents by manual labeling. Each document was marked with the dataset used in that document name. Finally, all the dataset names were collected together.

The baseline used in this work was a supervised classification based approach to identify terms which denote datasets used in a particular research document. In this approach, the structural information of the sentence around each word is used to create its local context. In this first set of experiments, a neighborhood of five words for each term considered for classification was used. The results of this approach were obtained by a ten-fold cross validation technique using a random forest decision tree.

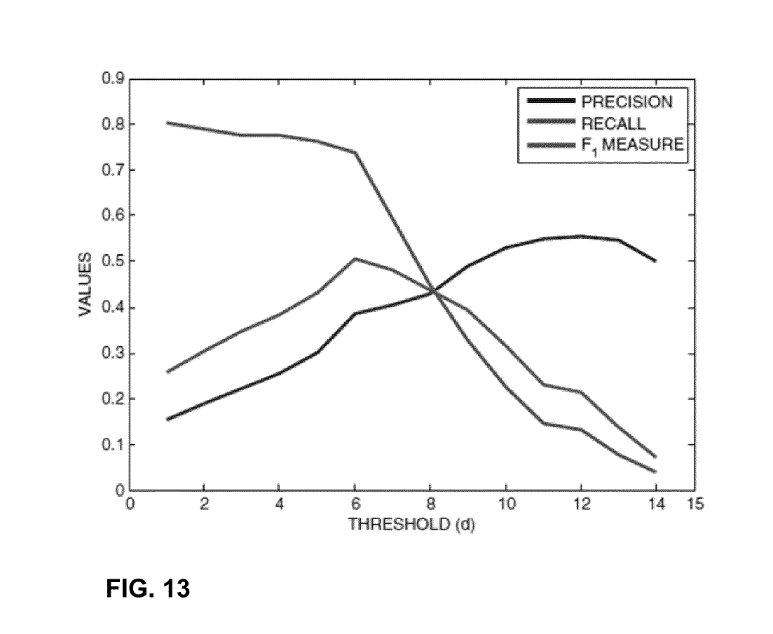

Standard performance evaluation metrics, such as precision, recall and F₁-measure, were used to evaluate and compare the performance of the proposed approach with the baseline approach. FIG. 13 shows the variation of precision, recall and F₁-measure with the threshold value. The optimum value of the threshold was determined by optimizing the F₁-measure value. As shown in FIG. 13, the F₁-measure is highest at a threshold value of six. Thus, 74% of the total correct datasets may be determined by using a threshold value of six for the frequency of the first right neighbor.

TABLE 1
Comparison of precision, recall and F₁-measure values for the
disclosed item finding algorithm and a baseline approach.

| | Precision | Recall | F₁-measure |
|---|---|---|---|
| Disclosed approach | 0.39 | 0.74 (74%) | 0.51 |
| Baseline | 0.52 | 0.38 (38%) | 0.44 |

The performance of the disclosed approach was then compared with the baseline. As shown in Table 1, the disclosed approach provides significant improvement in terms of recall. The recall increased to 74% in comparison to 38% when using the baseline approach which uses only the local context for identifying dataset names. In terms of precision, the baseline approach performed well, however, this high precision may be inherently due to the class imbalance problem in a classification setting. In other words, the number of instances identified in a minority class is already low which tends to favor the precision. However, recall is more important than precision in this experiment because there is a great deal of importance in identifying items which must be recommended. In addition and owing to the higher recall, a 7% improvement in the F₁ measure was observed.

The results of the first set of sub-experiments verified that the disclosed approach of using global context from search engines and using world knowledge base, such as a thesaurus, is more advantageous for finding dataset names used in computer science research than that of the baseline approach as described below.

In this second set of sub-experiments, a context creation for a user's interest is done by using an external corpus of research papers. As such, a corpus consisting of nine-thousand research documents from top-tier data mining forums was used wherein only those documents published between the years 2001 and 2010 were considered for purposes of this experiment. The metadata information associated with each research document was available from the DBLP bibliography corpus. In addition, twenty test queries were used on the user's side to denote the interest of twenty users. The twenty test queries consisted of research documents which were published in the year 2010. Research documents from the year 2010 were used as a test query in order to capture the prediction capabilities of the disclosed approach for identifying dataset names which were actually used in research at a later time.

For the purpose of testing, twenty test queries were considered in order to verify whether the disclosed approach could find datasets of relevance for a user's interest by using interest to item matching. As such, the ground truth was the actual dataset used in the document that was entered as query. All datasets were considered in the ground truth since there may be more than one datasets used in a single research document.

The strength of adding author based similarity to improve the context of a user's interest was evaluated in comparison to the standard content similarity based ranking in order to determine whether aggregating ranks obtained from author similarity improves the context creation for user's interest, and ultimately, providing relevant datasets to the user.

In order to compare the relevancy of the dataset recommended by the disclosed approach and the baseline approach, two evaluation criteria were used. First, the recall@k (R@k) was used and is defined as the ratio between the original datasets that appear in the top k recommendations for a user's query. The recall is averaged for all the user queries. This metric captures the exact match for the ground truth dataset and the datasets recommended in the top-k. Second, the co-usage probability (CUP), which captures the probability of co-usage of the original datasets and the recommended datasets, was used. For each pair of datasets (e.g., <d₀, dᵣ> wherein dₒ is the original dataset used and dᵣ is the recommended one), the probability that these two datasets have been co-used in the past may be calculated as follows:

$$CUP = \frac{hits ( {d}_{o} , {d}_{r} )}{hits ( {d}_{o} )} in an academic search engine$$

The counts of datasets were obtained using the exact phrase matching capability of search engines. The Google scholar search engine was used to find the exact count when a dataset dₒ appears in research documents and how many times dᵣ appear together with dₒ. For example, a query such as ‘“Epinions data”’ gives the count of documents in which “Epinions” and “data” appear adjacently to one another. The same search can be done to check if two datasets were referred as data together in some documents.

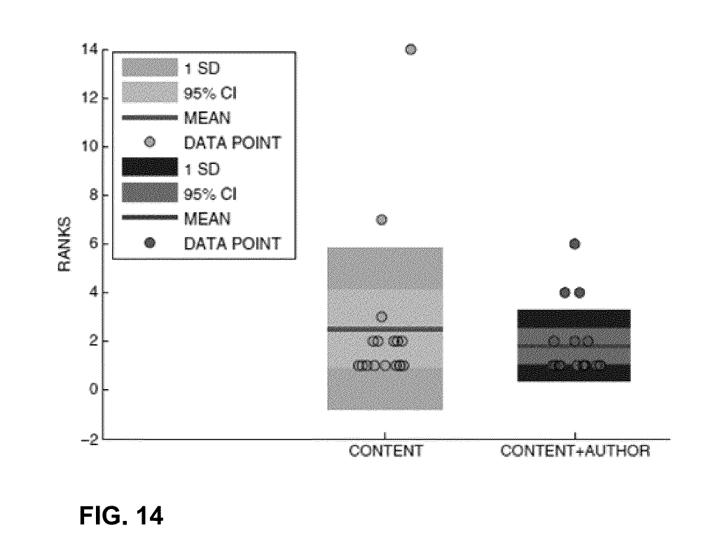

The disclosed approach was evaluated using both the content and author information for context creation against the baseline which uses only the content information for context creation. FIG. 14 is a graph that illustrates the comparison between the distributions of ranks at which the exact dataset was recommended for the twenty test queries. In other words, the ranks correspond to the position of the original dataset (e.g., the ground truth of the twenty test queries) in the top-k recommendation of the disclosed approach and the baseline approach. The box-plot illustrates the mean rank using the disclosed approach as being lower (i.e., 1.8) in comparison to the baseline approach (i.e., 2.5). In other words, on average, the correct datasets were identified within the top 1.8 of the recommendations when using the disclosed approach. FIG. 14 also shows a spread indicating that the variation of ranks when using the baseline approach is higher than when using the disclosed approach. The dots in the plot correspond to the individual results of the twenty test queries.

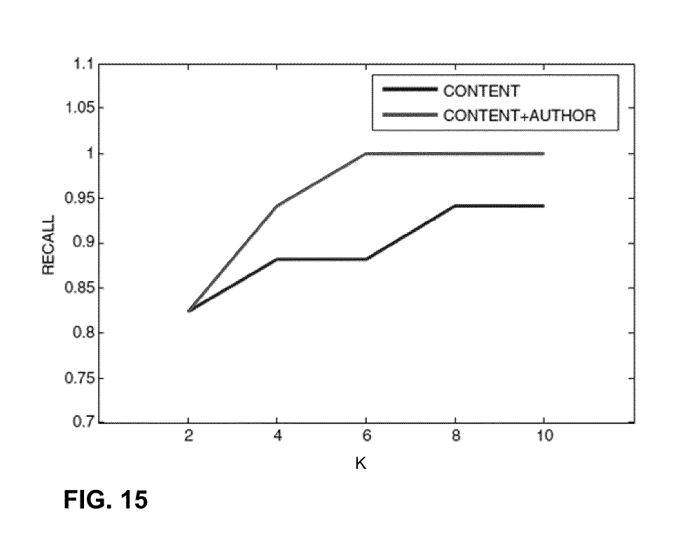

FIG. 15 is a graph that illustrates the variation of recall with k. The plot shows that the recall@2 was nearly 83% for both the baseline approach and the disclosed approach. However, the disclosed approach (i.e., content and author) outperformed the baseline approach (i.e., only content) at recall@4 by about 10%. Moreover, the recall@k further improved as k increased. Therefore, FIG. 15 illustrates that, by adding author similarity for context creation, the recall in top-4 significantly improves.

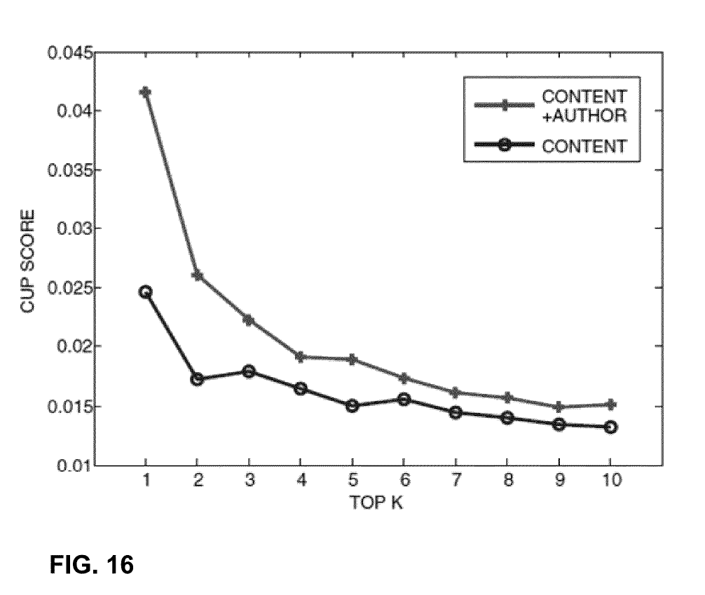

Next, the performance of the baseline approach and the disclosed approach was evaluated using the CUP criteria. As such, the CUP score was averaged for all the twenty test queries. FIG. 16 is a graph that illustrates the variation of the CUP score in the top-k recommendation. The CUP score was computed after eliminating the datasets which were exact matches in the ground truth. Thus, the CUP score for top-1 indicates that the first dataset in the recommendation was not an exact match. Higher CUP scores indicate a higher probability that a dataset in top-k was used with the original dataset in the ground truth. FIG. 16 illustrates that the appending of author-based-ranking with the content-based-ranking improved the probability of finding a dataset related to the ground truth dataset. In addition, the decreasing trend in the CUP score signifies that the probability of finding related datasets was higher in higher ranked recommendations than in lower ranked recommendations.

In summary, using information about the author when ranking successfully improved the context for a user's interest. In addition, the disclosed approach yielded improvement in both the recall@k and the CUP score.

In a second example experiment, performance of techniques described herein as illustrated by FIGS. 7 and 8 were evaluated and the results are described below. The following paragraphs describe the experimental design used to evaluate the performance. Evaluating a search engine's performance may be difficult for several reasons. For example, a search engine's performance should be evaluated using real world information where the user has a need for information and the same user then judges the results of retrieval. For the full quantitative evaluation of the search engine, there are two main requirements: (1) a log of user queries (information need) for research datasets, and (2) user's choice for most relevant dataset. However, such a gold standard dataset was not easily available. In order to overcome this limitation, a user study experiment was developed.

In order to develop a user based study, a web application was developed to provide users access to the DataGopher search engine. The web application consisted of three steps. First, the users were provided with login/access information. Second, the users were expected to fill a registration form (optional) and read the instructions for the evaluation experiment. Third, the users were given live access to the search engine. The users were free to query the database. In order to evaluate the search engine, the popular A-B type evaluation was performed. The users were shown two sets of results for the query they entered into the system. The two sets of results were obtained from DataGopher and a baseline search engine, respectively. However, the sources of both the result sets were anonymized. Given the two sets of results, the users were expected to choose which search engine performed better in relation to the other. For example, a questionnaire for evaluating the performance was solicited as follows: “Which, out of the following, is most relevant for the query: (1) Search engine ‘1’; (2) Search engine ‘2’; (3) Almost equal but Search engine ‘1’ is better; (4) Almost equal but search engine ‘2’ is better; or (5) Cannot decide.” Each user entered the query, as well as a response, towards the search results retrieved by different search engines.

The experiment was purposefully constructed as a free environment type evaluation. Fifteen users registered in the system logging approximately sixty-six queries. The web application access was provided to approximately thirty graduate students at the University of Minnesota and survey task in the Amazon Mechanical Turk portal.

The search engine, Bing™, was selected as the baseline search engine for this experiment for several reasons. First, the best possible comparison for the disclosed search engine model was a general purpose search engine which allows natural language querying. Second, a general purpose search engine was, arguably, the most popular choice for searching datasets. While data repositories do exist, they are mostly used as dataset look-up tables, and not as search systems for excavating the datasets as per research needs. Third, Bing is a robust search engine with many advanced technical features. Finally, Bing.com provides the API (Application Programmable Interface) for Bing search in the most convenient form both in terms of price and usability.

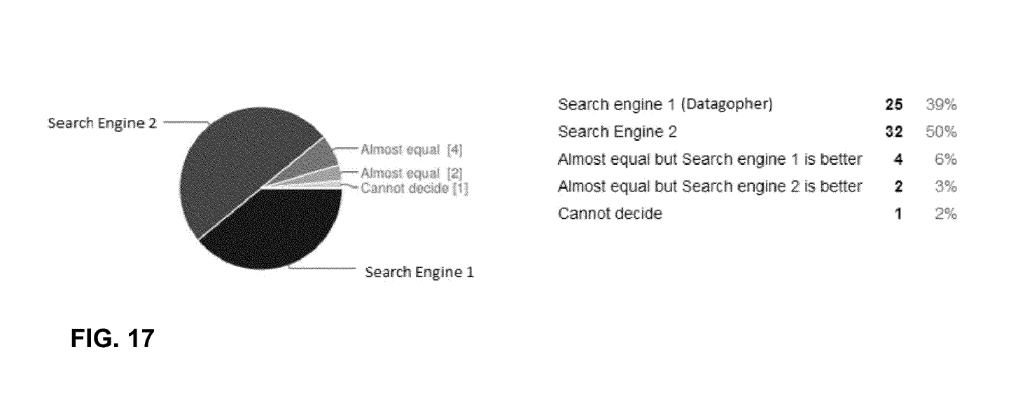

FIG. 17 is a graph that summarizes the results of the user study. As shown in FIG. 17, 50% of the user feedback favored the results of Search engine ‘2’, while 39% of them favored the results of Search engine ‘1’. In the 6% of the feedback, Search engine ‘1’ was slightly better than Search engine ‘2’, while in 3% of the cases, Search engine ‘2’ was slightly better than Search engine ‘1’. In addition, only 2% of the results were undecided. In order to bring the discussion into perspective, Search engine ‘1’ corresponds to the DataGopher system, while Search engine ‘2’ corresponds to the baseline system. Based on the statistics provided above, it would appear that the baseline search engine outperformed the DataGopher search engine performance. However, these results do not take into account the natures of the query input by the user. In a free environment user study, where the users are not rained to write test cases, it is important to take into consideration the quality of user input to gain a better perspective when viewing the comparison results.

The quality of the user input was judged in the following manner. As expected, the user queries varied greatly in terms of informational needs. The input queries were classified into two distinct categories based on the appearance of terms synonymous with the term “data” (e.g., data, dataset, network, record, etc.). For example, in the first category, all the user queries that did not contain terms synonymous with the term “data.” As such, this first category was labelled the “non-dataset query” category and comprised 40% of all search queries. The remaining of the queries were placed in the “dataset query” category and, as expected, comprised the remaining 60% of all search queries.

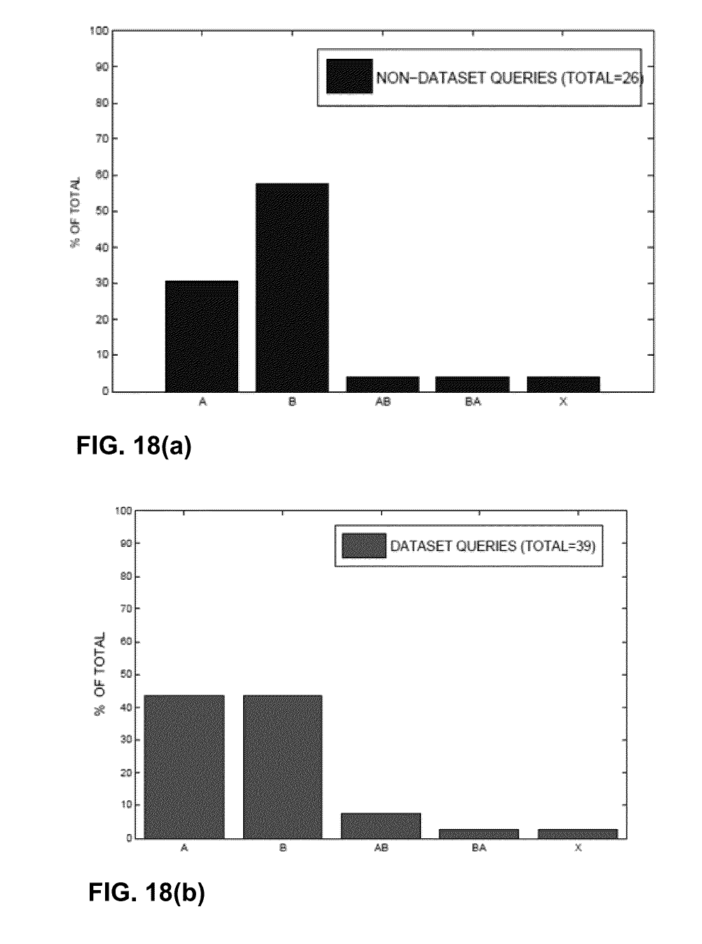

Based on the above mentioned categorization, the user study results were evaluated separately. FIG. 18(a) and FIG. 18(b) are graphs illustrating the distribution of the user responses over the different choices. As shown in FIG. 18(a), the distribution of the responses for non-dataset queries clearly favors the baseline performance Out of the twenty-six non-dataset queries, almost 60% of those were found to be better answered using the Bing search (as per the user study). Only 30% of the queries were better answered by DataGopher system. The content of these queries was analyzed, and several of the queries were found to be single words (e.g., “apple,” “poem,” “fruit,” etc.). In addition, a number of research related queries were entered (e.g., “numerical analysis,” “medical,” “people directory,” “text clustering,” etc.), but those queries were not considered as dataset queries because they did not contain terms synonymous with the term “data.” For a general purpose search engine (e.g., Bing!), a query missing terms synonymous with the term “data” will not invoke a dataset search. Hence, to ensure a fair comparison, they are considered non-dataset queries.

FIG. 18(b) illustrates the distribution of the responses over the different choices. As mentioned in previous paragraph(s), the queries evaluated in the “dataset query” category are more related to dataset searches. As shown in FIG. 18(b), both the DataGopher search engine and the baseline search engine perform equally well as indicated by the user feedback statistics. Out of the thirty-nine dataset queries, both the DataGopher results and the Bing results were favored approximately 45% of the time. Moreover, DataGopher was found to be preferred for 7% of the queries (out of thirty-nine) where the results were almost equally well, whereas the Bing search engine was preferred less than 2% of the time. The equal performance of the DataGopher system with the Bing system can be due to several different attributes. Based on observations of the dataset queries, several of those queries were not exactly found to be context based queries. As mentioned previously, the best performance of the DataGopher search engine was achieved when it was used for context based searches for research datasets. However, in a real world setting it is a challenge to get input from the user on informational needs in a pre-defined format. In that case, the results also support the effectiveness of the context based search even when the queries were not exactly context based. Other reasons for equal performance may be attributed to the corpus searched by Bing. Herein, the performance of the Bing search engine was not meant to be compared against because there are several intelligent techniques involved in their search system. However, it was intended to demonstrate the advantage of a context-based search system. In order to accomplish this goal, the potential of the dataset queries was subjectively evaluated as context-based dataset queries.

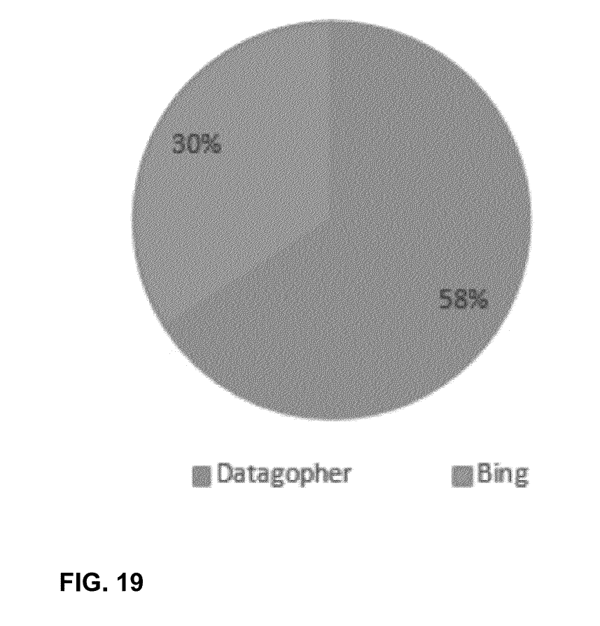

FIG. 19 is a graph illustrating instances in which the DataGopher and Bing search engines were judged as best answering context-based queries. As shown in FIG. 19, out of the nineteen context based queries, eleven (58%) of the queries were best answered by DataGopher (based on results of the user study) while only six (32%) of the queries were judged as being best answered by the Bing search engine. In sum, the disclosed search engine may be advantageous in the case of a context-based dataset search as described herein.

Various examples have been described. These and other examples are within the scope of the claims below.

What is claimed is:

1. A method comprising:
determining, by a computing device and based at least in part on information indicating a user interest, one or more items that are related to the user interest;
extracting, by the computing device and from the one or more items, a set of one or more objects related to the user interest; and
ordering, by the computing device, the set of one or more objects based at least in part on occurrences of each of the one or more objects within the one or more items.

2. The method of claim 1, wherein determining the one or more items that are related to the user interest comprises:
comparing the information indicating the user interest to each item from a plurality of items to determine respective levels of similarity between the information indicating the user interest and each item from the plurality of items; and
ordering at least two items from the plurality of items based at least in part on the respective levels of similarity for each of the at least two items.

3. The method of claim 2, wherein:
the information indicating the user interest comprises text data from a particular document;
the plurality of items comprises a plurality of research documents; and
comparing the text data from the particular document to each research document from the plurality of research documents comprises:
performing natural language preprocessing on the text data from the particular document,
determining a term frequency-inverse document frequency (TF-IDF) vector for the text data from the particular document, and
determining a respective cosine similarity between the TF-IDF vector for the text data from the particular document and a respective TF-IDF vector for the research document.

4. The method of claim 3, wherein the text data from the particular document comprises at least one of: a title of the particular document, or an abstract of the particular document.

5. The method of claim 2, wherein:
the information indicating the user interest comprises at least one author of a particular document;
the plurality of items comprises a plurality of research documents; and
comparing the at least one author of the particular document to each research document from the plurality of research documents comprises determining a semantic relatedness between the at least one author of the particular document and at least one author of the research document.

6. The method of claim 5, wherein determining the semantic relatedness comprises determining a minimum Normalized Google Distance between the at least one author of the particular document and the at least one author of the research document.

7. The method of claim 1, wherein extracting a set of one or more objects related to the user interest comprises:
extracting, from the one or more items, a set of potential objects;
performing an outlier selection on the set of potential objects to obtain a set of pruned potential objects;
performing, for each potential object from the set of pruned potential objects, a respective query, wherein the respective query comprises a search for a combination of: the potential object and an object type identifier; and
adding, to the set of one or more objects, each potential object from the set of pruned potential objects for which the respective query returns results that include the combination at least at a threshold frequency.

8. The method of claim 1, wherein the one or more items comprise one or more research papers.

9. The method of claim 1, wherein the one or more objects comprise one or more research data sets.

10. The method of claim 1, wherein the information indicating the user interest comprises information indicating a research paper.

11. A method comprising:
generating, by a computing device and based at least in part on an input research document denoting a user's interest, a context of the user's interest, the context comprising one or more research documents from a corpus of research documents;
identifying, by the computing device, one or more research datasets contained within the context; and
ranking, by the computing device, the one or more datasets based at least in part on rankings of each of the one or more research documents within which each of the one or more research datasets is contained.

12. The method of claim 11, wherein generating the context of the user's interest comprises determining, by the computing device, a research document of the one or more research documents is related to the input research document.

13. The method of claim 12, wherein the research document is related to the input research document according to one of content-based similarity and author-based similarity.

14. A method comprising:
collecting, by a computing device, a plurality of object identifiers corresponding to respective objects;
generating, by the computing device, respective contexts for the respective objects, each context comprising at least one text descriptor and at least one subject tag; and
indexing, by the computing device, a database of the objects using at least the respective contexts.

15. The method of claim 14, wherein collecting the plurality of object identifiers comprises at least one of:
extracting, by the computing device and from a corpus of documents, each of the plurality of object identifiers using natural language processing techniques and co-occurrence information from the web; or
scraping, by the computing device, open sourced repositories available via the web using an automated crawler and scraper to obtain each of the plurality of object identifiers.

16. The method of claim 14, wherein generating the respective contexts comprises:
performing, by the computing device, a search of an academic database for an object identifier from the plurality of object identifiers;
adding, to the context of the object identifier and as a text descriptor, at least one title of a search result; and
adding, to the context of the object identifier and as a subject tag, at least one subject tag of the search result.

17. The method of claim 14, wherein indexing the database of the respective objects comprises:
indexing, in the database, each of the objects using respective descriptions extracted from the web;
indexing, in the database, each of the objects using respective text descriptors; and
indexing, in the database, each of the objects using respective subject tags.

18. The method of claim 14, wherein each of the objects comprises a research dataset.

19. The method of claim 14, further comprising:
receiving an input query that specifies a user interest;
querying the database, using at least one index, to determine one or more objects that are relevant to the user interest; and
returning the one or more objects that are relevant to the user interest.

20. A computing device having a processor configured to:
determine, based at least in part on information indicating a user interest, one or more items that are related to the user interest;
extract a set of one or more objects related to the user interest from the one or more items; and
order the set of one or more objects based at least in part on occurrences of each of the one or more objects within the one or more items.

21. The computing device of claim 20, wherein the processor is configured to determine the one or more items that are related to the user interest by at least:
comparing the information indicating the user interest to each item from a plurality of items to determine respective levels of similarity between the information indicating the user interest and each item from the plurality of items; and
ordering at least two items from the plurality of items based at least in part on the respective levels of similarity for each of the at least two items.

22. The computing device of claim 21, wherein the information indicating the user interest comprises text data from a particular document,
wherein the plurality of items comprises a plurality of research documents, and
wherein the processor is configured to compare the text data from the particular document to each research document from the plurality of research documents by at least:
performing natural language preprocessing on the text data from the particular document,
determining a term frequency-inverse document frequency (TF-IDF) vector for the text data from the particular document, and
determining a respective cosine similarity between the TF-IDF vector for the text data from the particular document and a respective TF-IDF vector for the research document.

23. A computing device having a processor configured to:
collect a plurality of object identifiers corresponding to respective objects;
generate respective contexts for the respective objects, each context comprising at least one text descriptor and at least one subject tag; and
index a database of the objects using at least the respective contexts.

24. The computing device of claim 23, wherein the processor is further configured to:
perform a search of an academic database for an object identifier from the plurality of object identifiers;
add at least one title of a search result as a text descriptor to the context of the object identifier; and
add at least one subject tag of the search result as a subject tag to the context of the object identifier.

25. The computing device of claim 23, wherein the processor is further configured to:
receive an input query that specifies a user interest;
query the database, using at least one index, to determine one or more objects that are relevant to the user interest; and
return the one or more objects that are relevant to the user interest.

26. A computer-readable storage medium encoded with instructions that, when executed, cause at least one processor to:
determine, based at least in part on information indicating a user interest, one or more items that are related to the user interest;
extract a set of one or more objects related to the user interest from the one or more items; and
order the set of one or more objects based at least in part on occurrences of each of the one or more objects within the one or more items.
